(19) United States
(12) Patent Application Publication
(10) Pub. No.: US 2014/0313579 A1
(43) Pub. Date: Oct. 23, 2014

(54) HIGH CONTRAST PROJECTION SCREEN

(71) Applicant: 3M INNOVATIVE PROPERTIES COMPANY, St. Paul, MN (US)

(72) Inventors: Richard Y. Liu, Woodbury, MN (US); Francis V. Loncar, JR., Hudson, WI (US); David J. Koch, Woodbury, MN (US)

(21) Appl. No.: 14/359,318

(22) PCT Filed: Dec. 10, 2012
(86) PCT No.: PCT/US2012/068723

§ 371 Date: May 20, 2014

Related U.S. Application Data
(60) Provisional application No. 61/577,869, filed on Dec. 20, 2011.

(51) Int. Cl. G03B 21/56

(52) U.S. Cl. CPC G03B 21/56
USPC 359/449

(57) ABSTRACT

The present disclosure describes a front projection system. The front projection system includes a light absorbing layer having an absorbance in a visible range of the electromagnetic spectrum of at least 80% and a light diffusing layer disposed on the light absorbing layer between the light absorbing layer and the projector. The light diffusing layer includes a plurality of metal flakes uniformly distributed in a host material, an average size of the plurality of metal flakes being in a range from about 0.5 microns to about 20 microns, at concentration of in a range from about 3% to about 30% by weight. A plurality of light absorbing particles uniformly distributed in the host material at a concentration of less than about 7% by weight, and a major front surface facing the projector having an average surface roughness in a range from about 0.5 microns to about 10 microns.

### FIELD

The present disclosure relates to, among other things, projection screens. In particular, the present disclosure relates to a high contrast projection screens that utilize metal flakes distributed in a host material.

### BACKGROUND

Front projection screens used, for example in conference rooms, are based on white matte films or articles. The matte white screen can reflect all light sources from all incident angles in an equally efficient manner. The result is that even a slight ambient light from any light source will impact the projection quality of the image on the white matte screen surface. This can be manifested as loss of color saturation, lack of black color and/or poor contrast. Keeping the room completely dark can mitigate these issues, but even reflections off other surfaces in the room from the projected image can reduce image quality.

### BRIEF SUMMARY

The present disclosure relates to high contrast projection screens, among other aspects. In particular, the present disclosure relates to high contrast projection screens that have improved display quality over conventional matte white projection screens.

In many embodiments, a front projection system is described. The front projection system includes a light absorbing layer having an absorbance in a visible range of the electromagnetic spectrum of at least 80% and a light diffusing layer disposed on the light absorbing layer between the light absorbing layer and the projector. The light diffusing layer includes a plurality of metal flakes uniformly distributed in a host material, an average size of the plurality of metal flakes being in a range from about 0.5 microns to about 20 microns, and a concentration of the plurality of metal flakes in the host material being in a range from about 3% to about 30% by weight. A plurality of light absorbing particles uniformly distributed in the host material, a concentration of the plurality of light absorbing particles in the host material being less than about 7% by weight and a major front surface facing the projector and having an average surface roughness in a range from about 0.5 microns to about 10 microns.

The optical stacks and corresponding displays described herein may provide one or more advantages over prior projection screens or front projection systems. For example, prior projection screens and systems suffered from, for example, loss of color saturation, lack of black color and/or poor contrast due to ambient lighting reflection. This disclosure describes the use of metal flakes distributed in a host material to improve contrast, brightness and color saturation relative to prior projection screens. These and other advantages of the various embodiments of the optical stacks and displays described herein will be readily apparent to those of skill in the art upon reading the disclosure presented herein.

### BRIEF DESCRIPTION OF THE DRAWINGS

The disclosure may be more completely understood in consideration of the following detailed description of various embodiments of the disclosure in connection with the accompanying drawings, in which:

FIG. 1 is a schematic diagram of an illustrative projection system;

FIG. 2 is a schematic diagram side-view of an illustrative projection screen; and

FIG. 3 is a micrograph of the surface of Example 1.

The schematic drawings presented herein are not necessarily to scale. Like numbers used in the figures refer to like components, steps and the like. However, it will be understood that the use of a number to refer to a component in a given figure is not intended to limit the component in another figure labeled with the same number. In addition, the use of different numbers to refer to components is not intended to indicate that the different numbered components cannot be the same or similar.

### DETAILED DESCRIPTION

In the following detailed description, reference is made to the accompanying drawings that form a part hereof, and in which are shown by way of illustration several specific embodiments of devices, systems and methods. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise.

As used herein, “have”, “having”, “include”, “including”, “comprise”, “comprising” or the like are used in their open ended sense, and generally mean “including, but not limited to.” It will be understood that the terms “consisting of” and “consisting essentially of” are subsumed in the term “comprising,” and the like.

Any direction referred to herein, such as “top,” “bottom,” “left,” “right,” “upper,” “lower,” “above,” below,” and other directions and orientations are described herein for clarity in reference to the figures and are not to be limiting of an actual device or system or use of the device or system. Many of the devices, articles or systems described herein may be used in a number of directions and orientations.

The present disclosure describes high contrast projection screens, among other aspects. In particular, the present disclosure relates to high contrast projection screens that have improved display quality over conventional matte white projection screens. The use of metal flakes distributed in a host material to improve contrast, brightness and color saturation relative to prior projection screens. While the present disclosure is not so limited, an appreciation of various aspects of the disclosure will be gained through a discussion of the examples provided below.

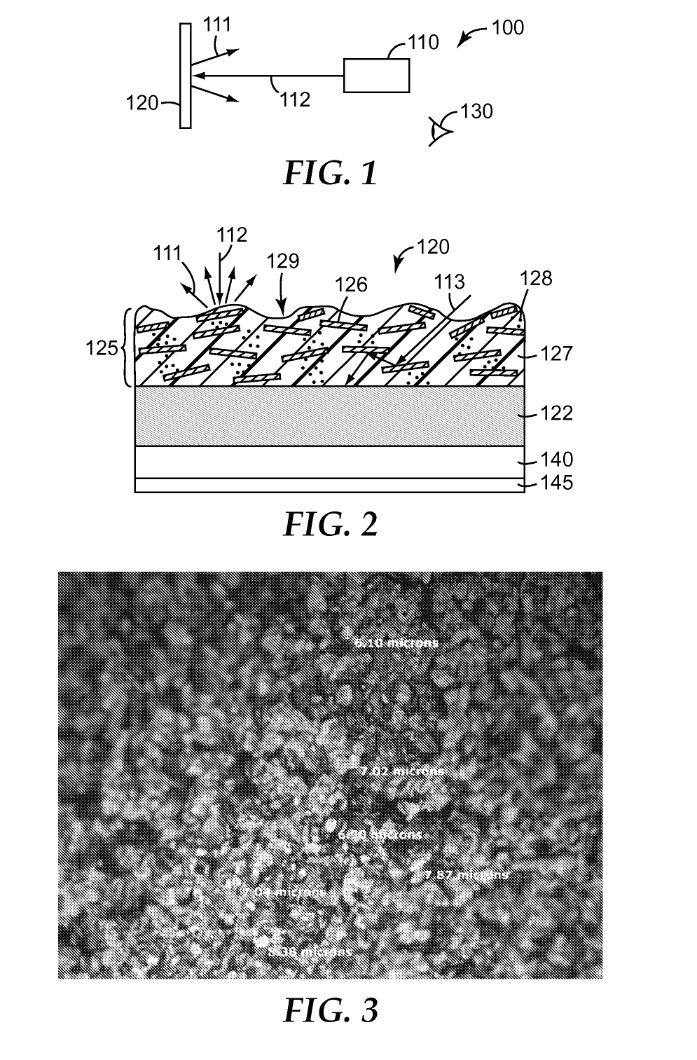

FIG. 1 is a schematic diagram of an illustrative projection system 100. The front projection system 100 includes a projector 110 projecting light 112 and a screen 120 receiving the projected light 112 from the projector 110 and reflecting light 111 to a viewing position 130. In many embodiments the projector 110 projects polarized light 112.

FIG. 2 is a schematic diagram side-view of an illustrative projection screen 120. The screen 120 includes a light absorbing layer 122. A light diffusing layer 125 is disposed on or adjacent to the light absorbing layer 122 between the light absorbing layer 122 and the projector 110. In some embodiments an adhesive layer 140 (e.g., a pressure sensitive adhesive layer) is disposed on the light absorbing layer 122 opposite the light diffusing layer 125. In these embodiments a liner 145 can be in contact with the adhesive layer 140 and configured so that the liner 145 can be removed from the adhesive layer 140 and expose the adhesive layer 140 to position the adhesive layer 140 and screen 120 to a desired substrate. In many embodiments, the screen 120 has a thickness in a range from 10 to 250 microns or from 25 to 125 microns, excluding an adhesive layer. The adhesive layer can add from 25 to 75 microns to the thickness of the screen 120.

The light absorbing layer 122 has an absorbance in a visible range of the electromagnetic spectrum of at least 80%, or at least 90%, or at least 95%. Light absorbing layer 122 can increase the contrast of a displayed image by absorbing projected light 112 and ambient light 113 that are not reflected by the metal flakes 126. Light absorbing layer 122 can include any light absorbing material that may be desirable and/or practical in an application. For example, layer 122 can include carbon black, light absorptive dyes such as black dyes or other dark dyes, light absorptive pigments or other dark pigments, or opaque particles, dispersed in a binder material. Suitable binders include thermoplastics, radiation curable or thermoset acrylates, epoxies, silicone-based materials, or other suitable binder materials.

The light diffusing layer 125 includes a plurality of metal flakes 126 distributed (e.g., uniformly) in a host material 127. The host material 127 can be formed of any suitable binder material such as, vinyl, polyurethane, Kraton, polyester, and other adhesives for example. The host material 127 can be any binder material that has proper adhesion to pigments and the metal or metalized flakes. The host material 127 can assist the flow of the mixture during the formation of the light diffusing layer 125. The metal flakes 126 can be either pure metal or elements having a metal or metalized surface.

In many embodiments the metal flakes 126 are selected from aluminum, silver or other metal with high reflectivity. The metal flakes 126 can be spherical, cornflake, disk or other multifaceted irregular shapes such as shattered glass chips. In many embodiments the metal flakes 126 are disk shaped or coin shaped.

The metal flakes 126 have an average size or lateral dimension in a range from about 0.5 microns to about 20 microns, or from 1 micron to about 15 microns, 1 micron to about 10 microns. In many embodiments a ratio of an average lateral dimension of the plurality of metal flakes 126 to an average thickness dimension of the plurality of metal flakes 126 is in a range from about 2 to 20. It has been found, in many embodiments, that when the metal flakes 126 are larger than about 25 microns, the screen surface appears to show sparkles which interfere with the image quality. It has been found, in many embodiments, that when the metal flakes 126 are smaller than about 0.5 microns, the screen surface becomes ineffective in reflecting light and a greater concentration of metal flakes 126 are needed to maintain the image quality.

A concentration of the plurality of metal flakes 126 in the host material 127 is in a range from about 3% to about 30% by weight, or from 3% to about 25% by weight, 4% to about 20% by weight. It has been found, in many embodiments, that when the metal flakes 126 concentration in the host material 127 is less than about 3%, the screen surface viewing angle becomes too narrow.

A plurality of light absorbing particles 128 can be uniformly distributed in the host material 127, a concentration of the plurality of light absorbing particles in the host material being less than about 7% by weight or from 1% to 4% by weight. The light absorbing particles 128 can be selected from pigments (organic and inorganic) of different colors to adjust the reflection spectrum and also to help maintain the color stability of the screen film 120. In many embodiments black pigments are utilized to absorb ambient light 113 at high incidence angle, as illustrated generally in FIG. 2.

A major front surface 129 facing the projector can have an average surface roughness in a range from about 0.5 microns to about 10 microns. In many embodiments the major front surface 129 facing the projector can have an average surface roughness in a range from about 0.5 microns to about 7 microns, or from about 0.5 microns to about 5 microns, or about 0.5 microns to about 3 microns. The major front surface 129 surface roughness can be formed via any useful method such as embossing, sandblasting, or micro-replication, for example. Surface roughness is measured by Mahr Surface Profilometer (POCKET SURF PS1, Mahr GmbH, Gottingen, Germany).

The front projection screens 120 described herein have improved contrast, brightness and color saturation relative to prior projection screens. In particular the screens 120 described herein exhibit an optical gain of at least 1, or at least 2 or at least 3. The screens 120 described herein exhibit a symmetric viewing angle of at least 25 degrees, or at least 35 degrees. The screens 120 described herein exhibit an average total reflectance in the visible range of electromagnetic spectrum of at least 60% or at least 70% or at least 80%. The screens 120 described herein an effective contrast enhancement of at least 300% over a matte white screen under ambient light condition (e.g., 200-400 lux) as measured on a checker-board pattern using a luminance meter.

Some of the advantages of the disclosed systems and constructions are further illustrated by the following example. The particular materials, amounts and dimensions recited in this example, as well as other conditions and details, should not be construed to unduly limit the present disclosure.

### EXAMPLES

### Example 1

A solution mixture was prepared by mixing 76.47 gram of clear vinyl solution (available from Dow Chemical under the trade designation PARALOID), 1.96 gram of black pigment (available from HUPC under the trade designation 2869F Black, Hangzhou, China), 19.61 gram of aluminum flakes (available from MetalFlake Corporation under the trade designation 011018 Silver, Ma., USA) and 1.96 gram of blue pigment (available from HUPC under the trade designation UN8632, Hangzhou, China) in a jar. The mixture was thoroughly stirred so that the components were dispersed evenly throughout the solution. The resulting mixture was then cast using a notch bar coating apparatus on a poly-coated paper liner at a wet thickness of about 125 microns (5 mil). The poly coated paper had a surface roughness (RA) of 1.7 microns. The mixture was then transferred to an oven and dried at about 130-160 degrees centigrade for about 3-6 minutes until it solidified into a film. The resulting film (Output Film 1) had a thickness of about 50 microns (2 mil).

A second mixture was prepared by mixing 90 gram of clear vinyl solution (available from Dow Chemical under the trade designation PARALOID) and 10 gram of black pigment (available from HUPC under the trade designation 2869F Black, Hangzhou, China). The mixture was thoroughly stirred so that the components are dispersed evenly throughout the mixture. The resulting mixture was then cast on top of the Output Film 1 at a wet coating thickness of about 125 microns (5 mil) using a notch bar coating apparatus. The cast coated article was then transferred to an oven and dried at about 130-160 degrees centigrade for about 3-6 minutes until the coating was solidified into a film. The resulting film has an overall thickness of about 100 microns (4 mil) after the liner was removed. The resulting screen film had gain of 2.0 and total viewing angle of about 54°. The contrast measurement at ambient light was about 34:1, which is about a 400% enhancement over a typical matte white screen tested below. FIG. 3 is a micrograph of the surface of Example 1.

### Comparative Example

A matte white screen (Da-Lite Matte White Screen) was tested as a comparative example. The gain was measured to be 1.0 and the total viewing angle was about 130°. The contrast in ambient light was about 7:1.

Thus, embodiments of HIGH CONTRAST PROJECTION SCREEN are disclosed. One skilled in the art will appreciate that the optical films and film articles described herein can be practiced with embodiments other than those disclosed. The disclosed embodiments are presented for purposes of illustration and not limitation.

Item 1 is a front projection system, comprising:
a projector projecting light;
a screen receiving the projected light from the projector and reflecting light to a viewing position, the screen comprising:
a light absorbing layer having an absorbance in a visible range of the electromagnetic spectrum of at least 80%; and
a light diffusing layer disposed on the light absorbing layer between the light absorbing layer and the projector, the light diffusing layer comprising:
a plurality of metal flakes uniformly distributed in a host material, an average size of the plurality of metal flakes being in a range from about 0.5 microns to about 20 microns, a concentration of the plurality of metal flakes in the host material being in a range from about 3% to about 30% by weight;
a plurality of light absorbing particles uniformly distributed in the host material, a concentration of the plurality of light absorbing particles in the host material being less than about 7% by weight; and
a major front surface facing the projector and having an average surface roughness in a range from about 0.5 microns to about 10 microns.

Item 2 is the front projection system of item 1, wherein the projector emits polarized light.

Item 3 is the front projection system of item 1, wherein the light absorbing layer has an absorbance in the visible range of the electromagnetic spectrum of at least 90%.

Item 4 is the front projection system of item 1, wherein the light absorbing layer has an absorbance in the visible range of the electromagnetic spectrum of at least 95%.

Item 5 is the front projection system of item 1, wherein the plurality of metal flakes comprise a plurality of aluminum flakes.

Item 6 is the front projection system of item 1, wherein the average size of the plurality of metal flakes is in a range from about 1 micron to about 15 microns.

Item 7 is the front projection system of item 1, wherein the average size of the plurality of metal flakes is in a range from about 1 micron to about 10 microns.

Item 8 is the front projection system of item 1, wherein a ratio of an average lateral dimension of the plurality of metal flakes to an average thickness dimension of the plurality of metal flakes is in a range from about 2 to 20.

Item 9 is the front projection system of item 1, wherein the concentration of the plurality of metal flakes in the host material is in a range from about 3% to about 25% by weight.

Item 10 is the front projection system of item 1, wherein the concentration of the plurality of metal flakes in the host material is in a range from about 4% to about 20% by weight.

Item 11 is the front projection system of item 1, wherein the plurality of light absorbing particles comprises a plurality of light absorbing pigments.

Item 12 is the front projection system of item 1, wherein the concentration of the plurality of light absorbing particles in the host material is in a range from about 1% to about 4% by weight.

Item 13 is the front projection system of item 1, wherein the major front surface of the light diffusing layer has an average surface roughness that is in a range from about 0.5 microns to about 7 microns.

Item 14 is the front projection system of item 1, wherein the major front surface of the light diffusing layer has an average surface roughness that is in a range from about 0.5 microns to about 5 microns.

Item 15 is the front projection system of item 1, wherein the major front surface of the light diffusing layer has an average surface roughness that is in a range from about 0.5 microns to about 3 microns.

Item 16 is the front projection system of item 1, wherein the screen has an optical gain of at least 1 when compared to a matte white screen.

Item 17 is the front projection system of item 1, wherein the screen has an optical gain of at least 2 when compared to a matte white screen.

Item 18 is the front projection system of item 1, wherein the screen has a symmetric viewing angle of at least ±25 degrees.

Item 19 is the front projection system of item 1, wherein the screen has a symmetric viewing angle of at least ±35 degrees.

Item 20 is the front projection system of item 1, wherein an average total reflectance of the screen in the visible range of the electromagnetic spectrum is at least 60%.

Item 21 is the front projection system of item 1, wherein an average total reflectance of the screen in the visible range of the electromagnetic spectrum is at least 70%.

Item 22 is the front projection system of item 1, wherein an average total reflectance of the screen in the visible range of the electromagnetic spectrum is at least 80%.

Item 23 is the front projection system of item 1, wherein an effective contrast enhancement of the screen is at least 300% over a matte white screen under an ambient lighting of about 200 to 400 lux.

What is claimed is:

1. A front projection system, comprising:
a projector projecting light;
a screen receiving the projected light from the projector and reflecting light to a viewing position, the screen comprising:
a light absorbing layer having an absorbance in a visible range of the electromagnetic spectrum of at least 80%; and
a light diffusing layer disposed on the light absorbing layer between the light absorbing layer and the projector, the light diffusing layer comprising:
a plurality of metal flakes uniformly distributed in a host material, an average size of the plurality of metal flakes being in a range from about 0.5 microns to about 20 microns, a concentration of the plurality of metal flakes in the host material being in a range from about 3% to about 30% by weight;
a plurality of light absorbing particles uniformly distributed in the host material, a concentration of the plurality of light absorbing particles in the host material being less than about 7% by weight; and
a major front surface facing the projector and having an average surface roughness in a range from about 0.5 microns to about 10 microns.

2. The front projection system of claim 1, wherein the plurality of metal flakes comprise a plurality of aluminum flakes.

3. The front projection system of claim 1, wherein the average size of the plurality of metal flakes is in a range from about 1 micron to about 10 microns.

4. The front projection system of claim 1, wherein a ratio of an average lateral dimension of the plurality of metal flakes to an average thickness dimension of the plurality of metal flakes is in a range from about 2 to 20.

5. The front projection system of claim 1, wherein the concentration of the plurality of metal flakes in the host material is in a range from about 4% to about 20% by weight.

6. The front projection system of claim 1, wherein the major front surface of the light diffusing layer has an average surface roughness that is in a range from about 0.5 microns to about 3 microns.

7. The front projection system of claim 1, wherein the screen has an optical gain of at least 2 when compared to a matte white screen.

8. The front projection system of claim 1, wherein the screen has a symmetric viewing angle of at least ±35 degrees.

9. The front projection system of claim 1, wherein an average total reflectance of the screen in the visible range of the electromagnetic spectrum is at least 80%.

10. The front projection system of claim 1, wherein an effective contrast enhancement of the screen is at least 300% over a matte white screen under an ambient lighting of about 200 to 400 lux.
